(19) United States
(12) Patent Application Publication
(10) Pub. No.: US 2020/0133199 A1
(43) Pub. Date: Apr. 30, 2020

(54) NORMALIZED PRINT USAGE DETERMINATION SYSTEM AND METHOD

(71) Applicant: Toshiba TEC Kabushiki Kaisha, Shinagawa-ku (JP)

(72) Inventors: Brad W. TOWE, Versailles, KY (US); Michael W. LAWRENCE, Lexington, KY (US)

(21) Appl. No.: 16/173,138

(22) Filed: Oct. 29, 2018

(51) Int. Cl. G03G 21/18; G03G 15/08; G03G 15/00; B41J 29/393; B41J 29/42

(52) U.S. Cl. CPC G03G 21/1889; G03G 15/08; B41J 29/42; B41J 29/393; G03G 15/50

(57) ABSTRACT

A system and method for generating a normalized page count for a printer includes an encoder that is coupled to the registration motor of the registration rollers. A memory stores an encoder count that is updated as encoder data is received from the encoder. A processor determines the normalized page count from the encoder count stored in memory. The normalized page count substantially reflects the equivalent number of standard pages printed by the printer. The normalized page count is stored as the page count for the printer.

### TECHNICAL FIELD

The subject application generally relates to a printer registration motor configured with an encoder to determine printer usage, and more specifically to determining a normalized page count using an encoder on a printer registration motor.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFP means any of the forgoing.

As with any mechanical device, MFPs are subject to wear and tear. Paper movement through an MFP can be problematic when a device's parts become worn from use. Significant human resource costs are associated with receiving a service call, logging a call, scheduling a service time, dispatching a service technician, and diagnosing and repairing a device. Such service costs can lower the distributor's profitability, increase the end user's cost per page, or both. It is advantageous for distributers to track print usage to determine when to proactively service or replace components. Usage is typically tracked by counting the number of pages printed on the MFP.

### BRIEF DESCRIPTION OF THE DRAWINGS

Various embodiments will become better understood with regard to the following description, appended claims and accompanying drawings wherein:

FIG. 1 is a block diagram of a multifunction peripheral;

FIG. 2 is a diagram of the paper path for a multifunction peripheral;

FIG. 3 is a diagram of an embodiment of a registration motor and associated encoder; and

FIG. 4 is a flowchart of example operations of an embodiment of a system for determining normalized page print usage.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In an example embodiment, an apparatus includes a registration motor configured to rotate registration rollers of a print engine. An encoder is coupled to the registration motor and generates encoder data that corresponds to rotation of the shaft of the registration motor. A memory stores an encoder count that is updated based on the received encoder data. A processor generates a normalized page count based on the encoder count. The normalize page count substantially reflects the equivalent number of standard sized pages printed by the print engine.

Embodiments herein provide for measuring and reporting normalized usage of print components. The systems and methods provide for more accurate estimates of printer usage for determining potential maintenance actions. Timely replacement of components can reduce the incidence of paper jams which can reduce downtime and the rate of service calls. Advanced warning allows a technician to be dispatched in advance to repair or replace potentially worn components before they become problematic. Advanced warning allows for scheduled maintenance at a time that is convenient to the customer. If a nearby service call is already scheduled, the technician can address the maintenance needs at the same time, increasing worker efficiency and reducing associated travel time necessary to maintain all of the MFPs in the field.

Modern printing devices monitor component wear and consumable usage over the usable life of the machine. These measurements are baselined against page count measure, typically from a sensor in the paper path that measures full actuations caused by passing pages. However, this can result in a deficient measurement baseline, as there are many sizes and orientations of paper that can be printed by a machine. Page count is therefore an inaccurate estimate of usage as not all pages are equal. For example, a printer that primarily prints legal sized documents will have more wear than a printer that primarily prints letter sized documents for the same page count.

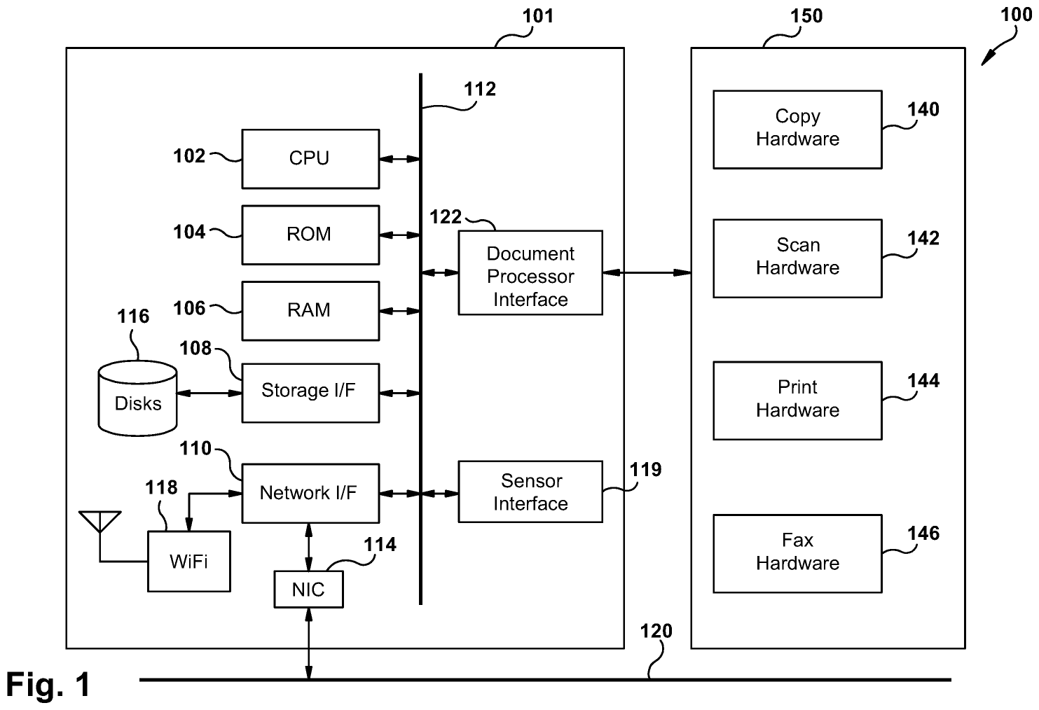

With reference to FIG. 1, an example document rendering system 100 is presented. The document rendering system 100 includes electrostatic-based, or toner-based, printing hardware 102 for performing printing operations as would be understood in the art. Illustrated is an example embodiment of a document rendering system 100 suitably comprised within an MFP. Included is controller 101 comprised of one or more processors, such as that illustrated by processor 102. Each processor is suitably associated with non-volatile memory such as ROM 104, and random access memory (RAM) 106, via a data bus 112.

Processor 102 is also in data communication with a storage interface 108 for reading or writing to a storage 116, suitably comprised of a hard disk, optical disk, solid-state disk, cloud-based storage, or any other suitable data storage as will be appreciated by one of ordinary skill in the art.

Processor 102 is also in data communication with a network interface 110 which provides an interface to a network interface controller (NIC) 114, which in turn provides a data path to any suitable wired or physical network connection 120, or to a wireless data connection via wireless network interface 118. Example wireless connections include cellular, Wi-Fi, Bluetooth, NFC, wireless universal serial bus (wireless USB), satellite, and the like. Example wired interfaces include Ethernet, USB, IEEE 1394 (FireWire), Apple Lightning, telephone line, or the like.

Processor 102 can also be in data communication with any suitable user input/output (I/O) interface which provides data communication with user peripherals, such as displays, keyboards, mice, track balls, touch screens, or the like. Hardware monitors suitably provides device event data, working in concert with suitable monitoring systems, for example monitoring subroutines executed by the processor 102. By way of further example, monitoring systems may include page counters, sensor output, such as consumable level sensors, temperature sensors, power quality sensors, device error sensors, door open sensors, and the like. Sensor data can be obtained from the sensors via a sensor interface 119. One such sensor can include an encoder sensor associated with a registration motor as detailed below. Data is suitably stored in one or more device logs, such as in storage 116.

Also in data communication with data bus 112 is a document processor interface 122 suitable for data communication with MFP functional units. In the illustrated example, these units include copy hardware 140, scan hardware 142, print hardware 144 and fax hardware 146 which together comprise MFP functional hardware 150. It will be understood that functional units are suitably comprised of intelligent units, including any suitable hardware or software platform.

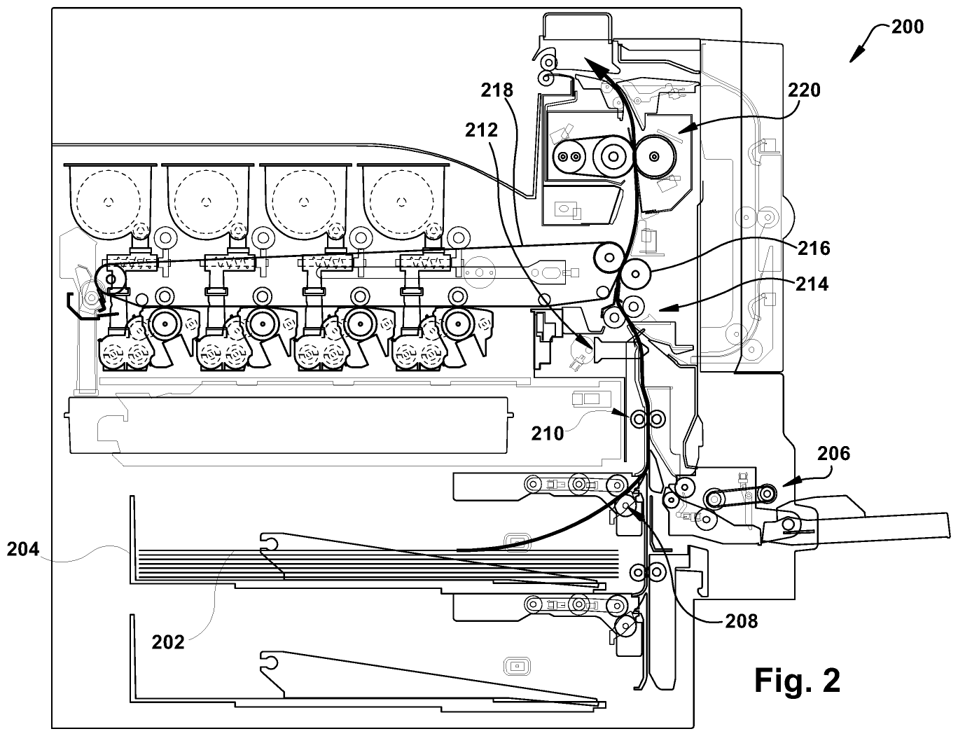

With reference to FIG. 2, a cross sectional view of an MFP 200 is illustrated. The paper path, illustrated by the arrowed line, starts with a paper 202 being picked up by rollers 208 from a paper tray 204 as shown, or from a sheet bypass feed 206. A pair of transport rollers 210 receives the paper 202 and urge the paper 202 past a position detection sensor 212 into the nip between the registration rollers 214. The registration rollers 214 urge the paper 202 towards the transfer roller 216 and the transfer belt 218 where toner is transferred to the paper 202. The paper 202 then enters the fuser 220 and the toner is fused to the paper 202 by heat.

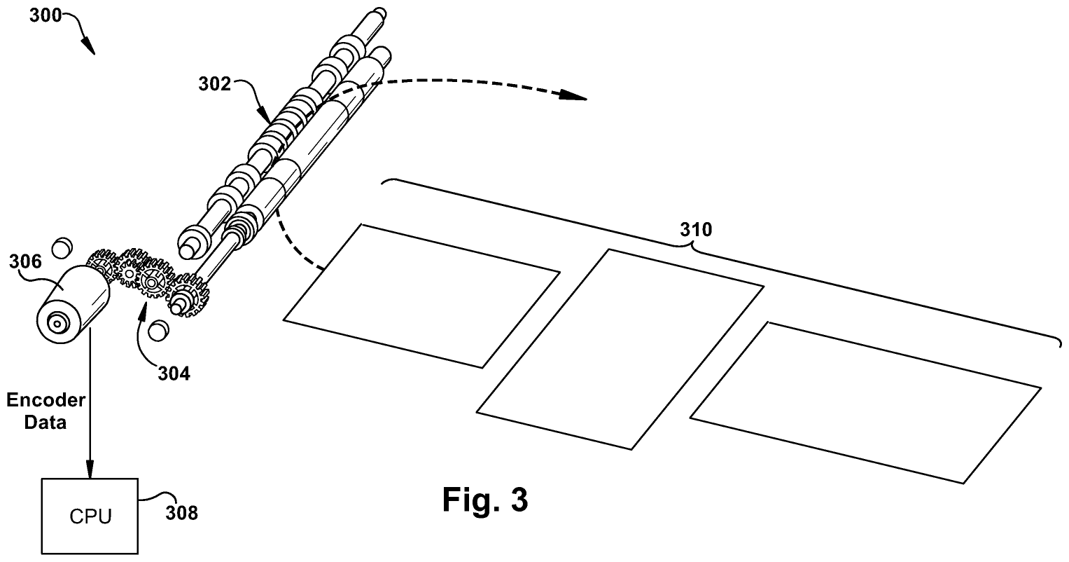

With reference to FIG. 3, a diagram of an embodiment of components for normalized page print usage 300 is illustrated. A registration motor 306 is configured with an encoder that transmits encoder data to a suitable processor 308 for determining page count. The registration motor 306 rotates gears of a gear box 304 that turns the registration rollers 302. Paper 310 of various sizes and orientations is urged along the paper path by the turning of the registration rollers 302.

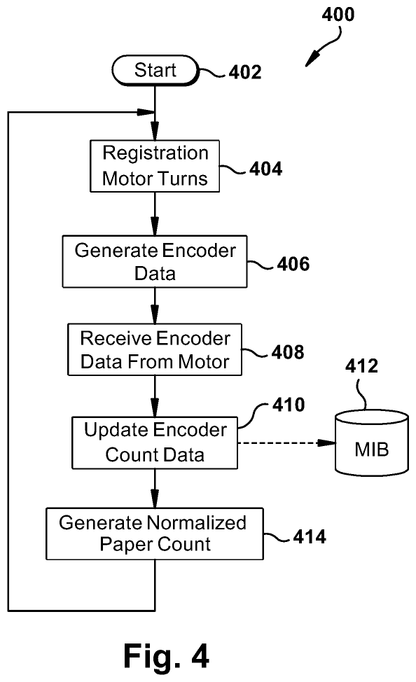

The encoder in the registration motor 306 provides a reliable measure of actual printer usage. All paper 310 must pass through the registration nip of the registration rollers 302, which offer little to no slip and only spin when feeding the paper 310. Measuring how much the registration motor 306 turns by the encoder produces encoder data, for example an encoder count, that can be normalized across a reference paper size by the CPU 308 to register a normalized page count as described below with reference to FIG. 4.

Although the encoder is described and illustrated as being positioned in the registration motor 306, the encoder can be positioned in other suitable components. For example, the encoder can be part of the gear box 304 or the registration rollers 302 however with substantially reduced resolution due to the turn reduction by the gear box 304. Similarly, the encoder can be part of other components in the paper path, however if those components continue to turn in the empty spaces between pages, or when paper is not in the paper path, the result will be potentially reduced accuracy.

FIG. 4 is a flowchart of example operations of an embodiment of a system for determining normalized page print usage. The process begins at start block 402 and proceeds to block 404 when printing commences in a print engine of an MFP and the registration motor is turned to rotate the registration rollers as paper is fed into the print engine.

Progress proceeds to block 406 where the encoder associated with the registration motor generates encoder data. For example, the encoder can use an optical transmitter and sensor that generates pulses based on the position of holes in a turning disk that is coupled to the shaft of the registration motor.

Progress proceeds to block 408 where the encoder data is received by a suitable processor, for example the intelligent controller 101 of FIG. 1 which can receive encoder data via signals received by the sensor interface 119.

Progress proceeds to block 410 where the encoder data is used to update a value stored in non-volatile memory, such as an encoder count data stored in a management information base or MIB 412. For example, the encoder count data can be a value that correlates with the number of turns of the registration motor during the lifetime of the printer.

Progress proceeds to block 414 where, based on the encoder data, the processor generates a normalized page count. For example, the processor can normalize the encoder count data against a selected standard paper size. The page count of the printer can be updated, for example by changing the actual count of pages printed by the printer to the normalized page count determined by the processor. In this way, the processor determines the equivalent number of standard sized pages that have been printed by the printer and uses that in lieu of the actual number of pages printed.

Current printers use actual page counts. However, depending upon the size and orientation of the pages, this may not reflect actual usage and associated wear-and-tear of printer components. For example, different countries can use different standard sizes of paper. Advantageously, use of the encoder allows for normalizing page count based on actual usage independent of what size paper is used. For example, 258 actual A4 pages printed could be normalized to 300 “pages” of equivalent usage by the above described system for determining normalized page print usage. This advantageously allows the MFP to continue to provide the existing page count attribute to monitoring systems for tracking print usage, but which more accurately reflects the actual usage of the printer. Normalized page print usage therefore advantageously provides a more accurate indicator for determining printer overall life, consumable remaining life, and wear component life.

In light of the foregoing, it should be appreciated that the present disclosure significantly advances the art of determining printer usage. While example embodiments of the disclosure have been disclosed in detail herein, it should be appreciated that the disclosure is not limited thereto or thereby inasmuch as variations on the disclosure herein will be readily appreciated by those of ordinary skill in the art. The scope of the application shall be appreciated from the claims that follow.

1. An apparatus, comprising:
a registration motor configured to rotate registration rollers of an associated print engine;
an encoder coupled to the registration motor and configured to generate encoder data corresponding to rotation of a shaft of the registration motor;
a memory configured to store an encoder count data based on the encoder data; and
a processor configured to generate a normalized page count based at least in part on the encoder count data.

2. The apparatus of claim 1, wherein the processor is further configured to update in the memory an encoder count based on the received encoder count data.

3. The apparatus of claim 2, wherein the processor is configured to generate the normalized page count from the encoder count.

4.

5.

6. The apparatus of claim 1, wherein the encoder is disposed on a shaft of the registration motor.

7. The apparatus of claim 6, wherein the encoder data correlates with a number of revolutions of the shaft of the registration motor.

8.

9. A multifunction printer, comprising:
an intelligent controller comprising a processor and associated memory;
a print engine operable to perform a print operation in accordance with instructions from the intelligent controller; and
an encoder coupled to a registration motor of the print engine, the encoder configured to generate encoder data corresponding to rotation of the registration motor during the print operation,
wherein the processor is configured to
receive the encoder data from the encoder, and
determine a normalized page count based at least in part on the encoder data.

10. The multifunction printer of claim 9, wherein the encoder is disposed on a shaft of the registration motor.

11.

12. The multifunction printer of claim 9, wherein the processor is further configured to update, in the memory, an encoder count based on the received encoder count data.

13. The multifunction printer of claim 12, wherein the processor determines the normalized page count from the encoder count.

14.

15. The multifunction printer of claim 9, wherein the processor is further configured to store, in the memory, the normalized page count as the actual page count for the multifunction printer.

16.

17.

18.

19.

20.

21. The method of claim 15, further comprising:
generating, by an encoder disposed on a shaft of a registration motor associated with the registration rollers, the encoder data,
wherein the encoder data correlates with the number of revolutions of a shaft of the registration motor.
